(19) United States
(12) Patent Application Publication
(10) Pub. No.: US 2017/0153008 A1
(43) Pub. Date: Jun. 1, 2017

(54) LUMINESCENT MATERIAL WITH TEXTURED PHOTONIC LAYER

(71) Applicant: Saint-Gobain Cristaux Et Detecteurs, Courbevoie (FR)

(72) Inventors: Sébastien LE ROY, Houilles (FR); Emmanuel MIMOUN, Boulogne-Billancourt (FR)

(21) Appl. No.: 15/382,400

(22) Filed: Dec. 16, 2016

Related U.S. Application Data
(63) Continuation-in-part of application No. PCT/FR2015/051605, filed on Jun. 17, 2015.

(30) Foreign Application Priority Data
Jun. 23, 2014 (FR) 1455809

(51) Int. Cl. F21V 9/16; G01T 1/20; G01T 1/202

(52) U.S. Cl. CPC F21V 9/16; G01T 1/2023; G01T 1/2006

(57) ABSTRACT

The invention relates to a luminescent material comprising a face coated with a textured layer, the texture of said layer comprising identical features distributed uniformly over said face, said layer decreasing the angle of the extraction cone of light emitted by said luminescent material and passing through said face. The luminescent material may be of the scintillator type or of the wavelength converter type.

### CROSS-REFERENCE TO RELATED APPLICATION

The present application is a continuation-in-part of and claims priority under 35 U.S.C. §120 to International Application No. PCT/FR2015/051605, filed Jun. 17, 2015, which claims priority to French Patent Application No. 1455809, filed Jun. 23, 2014, both of which applications are incorporated by reference herein in their entireties.

### FIELD OF THE DISCLOSURE

The invention relates to the field of luminescent materials, especially of the scintillator type, for detecting ionizing radiation, and also of the wavelength converter type.

### DESCRIPTION OF RELATED ART

Ionizing radiation (which includes ionizing particles such as especially protons, neutrons, electrons, alpha particles, ions and X- or gamma rays) is conventionally detected using scintillators, often single crystals, that convert the incident radiation into light, which is then converted into an electrical signal using a photoreceiver such as a photomultiplier. The scintillators used may especially be made of single crystals of thallium-doped sodium iodide (denoted NaI(Ti) below), thallium- or sodium-doped cesium iodide, or cerium- or praseodymium-doped lanthanum halide. Crystals based on lanthanum halide may be promising in terms of light intensity and resolution.

Certain luminescent materials such as YAG (cerium-doped yttrium aluminate) are used in projection lamps in order to convert invisible light, especially in the UV, into visible light and thus to increase the amount of light projected in the visible. This increase in intensity may be used to increase the contrast of an image.

The light emitted by a scintillator is received by a photodetector possibly of the photomultiplier, photodiode or CCD type, etc. in many applications the photodetector is optically coupled to the scintillator via direct contact or by way of a very thin window possibly taking the form of a single thin layer of grease. For this type of coupling, on account of the immediate proximity between the scintillator and the photodetector, the exit angle of the light from the scintillator often is of less importance. However, even in this case, the angle may have a certain importance: 1) for (row or pixel) spatial detectors, a perpendicular angle of incidence decreases crosstalk and increases the clearness of the image, 2) silicon photodetectors have high refractive indices and reducing perpendicular incidence decreases Fresnel reflection and improves efficiency, 3) for a photomultiplier tube, a perpendicular incidence yields photoelectrons with a narrower energy dispersion and therefore a better resolution. The light exiting the scintillator is generally quasi-Lambertian, meaning that the light exiting from the exit face of the scintillator has a very wide angular distribution. This light is however often satisfactorily collected by the photodetector.

However certain applications, such as high-energy electron accelerator radiography, MRI-PET, imaging of the core of a reactor and imaging in the human body, employ optical coupling over a greater distance between the exit face of the light of the scintillator and the photodetector. These applications make use of an optical system separating the photodetector from the scintillator such as an optical fiber or a lens. For these applications, it is particularly important to decrease the exit angle of light from the exit face of the scintillator. By decreasing this angular distribution, the amount of light detected is increased. In addition, for the case where the photodetector is by nature sensitive to the angle of incidence of the light, decreasing the angular distribution of the light exiting the scintillator allows a more uniform photodetector response to be obtained. To decrease the angular distribution of the light exiting from the exit face of the scintillator, it would not in principle be recommended to use, which means that would increase the randomness of paths taken by light in the crystal, especially such as roughening the external surface of the crystal.

### BRIEF DESCRIPTION OF THE DRAWINGS

Embodiments are illustrated by way of example and are not limited by the accompanying figures. The figures are not to scale.

FIG. 1 includes an illustration including a scintillator coupled to a photodetector in accordance with an embodiment.

FIG. 2 includes an illustration of an exemplary projection lamp in accordance with an embodiment.

FIG. 3 includes an illustration of a portion of a luminescent material in accordance with an embodiment.

FIG. 4 includes an illustration of a portion of a luminescent material in accordance with another embodiment.

FIG. 5 includes a graph illustrating light extraction of scintillators having different textured layers.

FIG. 6 includes a graph illustrating light extraction of scintillators in accordance with embodiments herein.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and can be found in textbooks and other sources within the arts, to which the present disclosure belongs.

According to the present disclosure, a textured photonic crystal can be placed on the light exit surface of a light-emitting luminescent material in order to channel the light exiting said luminescent material into a cone of narrower angle. In the case of a luminescent material of the scintillator type, such as being a scintillator material or a scintillator, the photonic crystal can collimate the light so that coupling of a scintillator to a photodetector can be more efficient and uniform over the entire exit surface of the scintillator/photonic crystal system. In other applications of a luminescent material, especially in a projection lamp application, light can be better directed toward a target, such as an image.

Embodiments of the present disclosure firstly relates to a luminescent material, especially of the scintillator type, comprising a face coated with a textured layer, the texture of said layer comprising identical features distributed uniformly over said face, said layer decreasing the angle of the extraction cone of light emitted by said luminescent material and passing through said face. According to an embodiment, a textured layer can include a textured photonic crystal.

Particularly, in an embodiment, the light exiting the luminescent material can be more tightly confined in a cone of smaller apex angle, thereby improving its collection. The texture of the photonic crystal can include a periodic structure, the period of which can be similar to the wavelength of the light emitted by the scintillator.

According to an embodiment, the textured layer can include an array of identical pads or holes regularly arranged over the light exit surface of the luminescent material. In a particular embodiment, the textured layer can consist of an array of identical pads or an array of identical holes regularly arranged over the light exit surface of the luminescent material. Features of the textured layer (e.g., pads or holes) may be characterized by a height H and a characteristic size D. As used herein, the height H refers to the thickness of the layer. The features can be identical and arranged periodically spaced apart from one another. In a given layer, a deviation of at most 10% in H relative to the arithmetic mean of H is tolerable, and a deviation of at most 10% in D relative to the arithmetic mean of D is tolerable, because these deviations in certain features may not prevent them from being considered to be identical to the others. The features may have any shape, such as, having the shape of a cylinder the axis of which lies perpendicular to the exit surface. These features have a characteristic size corresponding to their largest dimension parallel to the exit surface. This characteristic size is called “D”. If the features have a square or rectangular cross section parallel to the exit surface, D corresponds to the diagonal of said squares or rectangles. If the features are cylinders the axes of which lie perpendicular to the exit surface, then D corresponds to the diameter of the cylinders.

The features can be regularly repeated over the entire surface of the luminescent material by successive and optionally combinatorial translation with two vectors \vec{v} and \vec{w} in the plane of the light exit surface. The angle between the vectors can be between 0° and 90°. Thus, a square organization corresponds to vectors \vec{v} and \vec{w} of the same length making an angle of 90° to each other whereas a hexagonal organization corresponds to vectors \vec{v} and \vec{w} of the same length making an angle of 60° to each other. The distance referred to as “a” between two neighboring features is the smallest of the lengths of the vectors \vec{v} and \vec{w}.

If λ_{SC} is the wavelength of maximum emission (corresponding to the maximum of the emission peak) of the light exiting a luminescent material, λ_{SC}/a can be in the range extending from 0.5 to 1.5, and preferably from 0.8 to 1.3 and more preferably from 0.85 to 1.1.

In a particular embodiment, D/a can be in the range extending from 0.2 to 0.8. The thickness H of the layer can be in the range extending from 10 nm to 1000 nm, and preferably between 100 and 500 nm.

The coated luminescent material according to embodiments herein can be particularly suitable for optical coupling systems with small acceptance angles. For instance, the acceptance angle can be less than 45°, less than 20°, or less than 10°. Embodiments of the present disclosure also relate to a device comprising a scintillator material of embodiments herein, coupled to at least one photodetector via the coated face having the textured layer by way of an optical coupling system with acceptance angles of less than 45°, less than 20°, or even less than 10°.

The smaller the exit angle of the light is, the more advantageous it is for λ_{SC}/a to approach 1. The texture layer according to embodiments herein, can help to obtain an increase in light extraction (measured in watts) of larger than 50%, larger than 100%, or larger than 150%. It is possible to measure this increase by measuring the power in watts output from an imaging system (consisting for example of a lens of known focal length and diameter) with a given acceptance angle. The measurement is then carried out at the focal point of the lens. It may be desired for the exit angle to be small because of the small acceptance angle of an optical coupling system, especially in the case of coupling between a scintillator material and a photodetector.

According to an embodiment, the textured layer can be applied to the light exit surface of the luminescent material, particularly when the luminescent material is used as a scintillator. In particular, it may be a question of the exit face of light from a scintillator that it is required to couple to a photodetector by way of an optical system having a given acceptance angle, for example 20° for an optical fiber. How the other surfaces of the luminescent material are treated can also have an influence on the amount of light extracted. It has been observed, especially in the case of a scintillator, that surprisingly better results are obtained if at least one of the the other surfaces or all of the other surfaces are rough and covered with a reflector of light. Roughness can effectively make the angle and position of the light at the exit interface of the scintillator completely random. However, it is this type of surface treatment that has yielded the best results. The roughness of the surfaces is obtained in a known way by sanding, for example with sandpaper. In a particular embodiment, the sandpaper can be P200 to P1000 type. The reflector of light is preferably white and may be applied to the rough surface by application of a strip of a reflective material such as polytetrafluoroethylene (PTFE), especially the PTFE sold under the trade name Teflon™. Applying a strip of reflective material to a rough surface of the scintillator traps air between the strip and the scintillator, which is advantageous. According to another particular embodiment, those faces of the scintillator that are not coated with the textured layer can be rough, such as having a roughness that is sufficient to trap air between the scintillator and a reflective material, and coated with a reflective material, especially PTFE, leaving air between the scintillator and the reflective material.

According to an embodiment, the textured layer can have a refractive index close to that of the luminescent material, such as in the range extending from 0.8 to 1.2 times, and preferably 0.9 to 1.1 times the refractive index of the luminescent material. According to another embodiment, the textured layer can be made of a material that is transparent to the wavelength of the light exiting the luminescent material. The material of the textured layer can be firstly chosen for its compatibility with the luminescent material from the point of view of refractive index. Examplery material of the textured layer can include silicon nitride or titanium oxide. In a particular embodiment, the textured layer can be made of silicon nitride or titanium oxide. The texture may be produced by lithography, e-beam milling or by embossing of a sol-gel layer.

According to an embodiment, the luminescent material of the scintillator type may especially be of the LSO, LYSO, LuAP, YAG, NaI, CsI, GSO, BGO, CLYC, CLLB, LaCl₃, LaBr₃ or Gd₂O₂S:Pr:Ce (called “GOS”) type, and any or all of these materials can contain a dopant element appropriate to their scintillation. According to another embodiment, the luminescent material of the scintillator type may also be BGO (Bi₄Ge₃O₁₂), CDO (CdWO₄), PWO (PbWO₄) or CsI. A scintillator emits at a precise wavelength and the width of its emission peak depends on its nature. An LYSO scintillator conventionally emits at about 420 nm. A CLYC scintillator (family of Cs₂LiYCl₆) generally emits at about 365 nm. The aforementioned wavelength λ_{SC} is the wavelength corresponding to the apex of the characteristic light emission peak of the scintillator. In a particular embodiment, the luminescent material of the scintillator type can be a single crystal.

According to an embodiment, the luminescent material can be of the wavelength converter type. For instance, the luminescent material may be of the YAG type, i.e. an yttrium aluminum garnet doped with cerium (YAG:Ce). By way of example, mention may be made of Y_{2.99}Al₅Ce_{0.01}₁₂. This material converts UV light into visible light. The luminescent material of the wavelength converter type may also be Gd₃(Al₁₋ₓGaₓ)₅O₁₂:Ce (called “GAG:Ce”) or (Gd_{1-y} Y_{y})₃(Al₁₋ₓGaₓ)₅O₁₂:Ce (called “GYGAG:Ce”). Thus, the luminescent material of the wavelength converter type may be of the YAG or GAG or GYGAG type, and especially of the YAG:Ce or GAG:Ce or GYGAG:Ce type.

The luminescent material, especially of the scintillator type, may be a single crystal or polycrystalline. In the case of a polycrystalline material, a powder of the material can be compressed in order to be converted into a pellet. In a projection lamp application, the luminescent material can be used in the form of a thin plate, having a thickness between 0.05 and 0.2 mm. The plate can receive the incident light via one face, be passed through by this light and emit the emergent light via the other face. In the case of a luminescent wavelength-converter material, the emergent light can include higher intensity of visible light, as the luminescent material can convert some of the invisible incident UV light into visible emergent light. Thus, embodiments of the present disclosure also relate to a projection lamp comprising a light source and a plate of the luminescent material of embodiments herein, said luminescent material being of the wavelength converter type, the light source emitting the light toward the first face of the plate, the second face of the plate being coated with the textured layer. In particular, the luminescent material can advantageously convert invisible incident (on the first face) light into visible emergent (from the second face) light. The light emitted by the luminescent material can pass through the textured layer then emerge from the textured layer, said textured layer decreasing the angle of the extraction cone of the emitted light, compared to the same device without a textured layer.

According to the present disclosure, a luminescent material of the scintillator type, coated with the photonic layer, can be advantageous especially for detection devices requiring an optical system implying a large distance between the scintillator and the photodetector. Thus, at least one embodiment of the present disclosure especially relates to a device comprising a scintillator material of embodiments herein coupled to a photodetector via the face coated with the textured layer, said detector being separated from the scintillator material by a distance of at least 5 cm, or even at least 1 m. By way of example, mention may be made of the following two uses of this type:

a) In imaging, and especially medical imaging, the use of areas of matrices of pixels made of a scintillator material, with a camera directed toward said area. The camera may be a CCD camera or a cinematographic camera or a high-speed digital camera. This may be useful in radiography in the case where the photodetector must be far from the radiation source or from electromagnetic noise. High-energy electron accelerator radiography is one concrete example.

b) Sometimes, optical fibers can be coupled to scintillator pixels with the aim of placing the photodetector at a sufficient distance from the radiation source or in order to decrease the size of the instrument in proximity to the pixels. A narrow light emission cone means that more light is within the critical angle for total internal reflection. Specific examples using this technique are imaging employing high magnetic fields such as MRI (MRI-PET, for example), imaging in the cores of reactors, imaging in the human body or in animals (imaging of the colon, for example).

In case b) above, according to an embodiment, the scintillator material can be coupled to a plurality of photodetectors via the face coated with the textured layer. The present disclosure provides an advantage not only because of the large distance between the material and the photodetector, but also because of the plurality of photodetectors, on account of the need to separate the radiation intended for each photodetector.

The present disclosure is also advantageous for certain devices in which the photodetector is very close to the scintillator. By way of example, mention may be made of the following four uses of this type:

a) Matrices of linear pixels are used in tomodensitometry imaging. Crosstalk may occur between photodiodes when the light originating from a neighboring pixel enters into a photodiode. This causes haze in the reconstruction of the image. The present disclosure allows this crosstalk to be decreased by making the light pass more directly into the closest photodiode.

b) The principal reason for which photodiodes made of silicon are not 100% efficient with respect to detection of photons is that silicon has a high refractive index and is too reflective. Photons that approach the silicon perpendicularly are less subject to Fresnel reflection. Thus, scintillation light that is more concentrated in a narrow cone perpendicular to the surface of the silicon will have a higher chance of being transmitted. Thus, silicon photodetectors will deliver a more intense signal.

As in the case of the preceding application, the light approaching the window of a photomultiplier tube (PMT) is not only less reflected, but in addition the photoelectrons generated from the photocathode have a narrower energy distribution. This results in a lower gain variation in the PMT and a better energy resolution. Thus, gamma spectrometers with a higher resolution can be obtained according to embodiments herein.

According to the present disclosure, multi-anode photomultiplier tubes (PMT) benefit from a higher percentage of near-perpendicular photons. These photons scatter less in the glass window and therefore crosstalk is decreased and spatial resolution increased. These multi-anode PMTs are used in medical imaging such as PET and SPECT imaging.

In case a) above, the scintillator material is coupled to a plurality of photodetectors via the coated face of the textured layer. In cases b), c) and d) above, the power response of the photodetector to an incident ray varies by more than 10% when the angle of incidence relative to the normal to the receiving surface of the photodetector is varied from 0 to 80°. By substantially decreasing the variation in the angle of incidence relative to the normal to the receiving surface of the photodetector, embodiments herein provide a substantial advantage.

FIG. 1 shows a scintillator 1 the light exit face of which is coated with the layer 2 according to an embodiment. The scintillator can be made of the luminescent material disclosed herein. The other faces of the scintillator can be rough and coated with a material 3 that reflects light. The textured light exit face makes contact with a face of an optical coupler 4. The other face of the optical coupler 4 transmits the light to a photodetector 5.

FIG. 2 shows a projection lamp using as light source a diode 20. The latter emits light into the volume 21, generally under vacuum. The internal lateral walls 22 reflect the light. A plate 23 of YAG receives the light via a first face directed toward the interior of the volume 21. The second face of the plate 23 directed toward the exterior is equipped with a textured layer 24 that channels the light into a cone of small angle. Depending on the luminescent material used, the invisible light emitted by the light source may be converted during the passage through the plate into visible light.

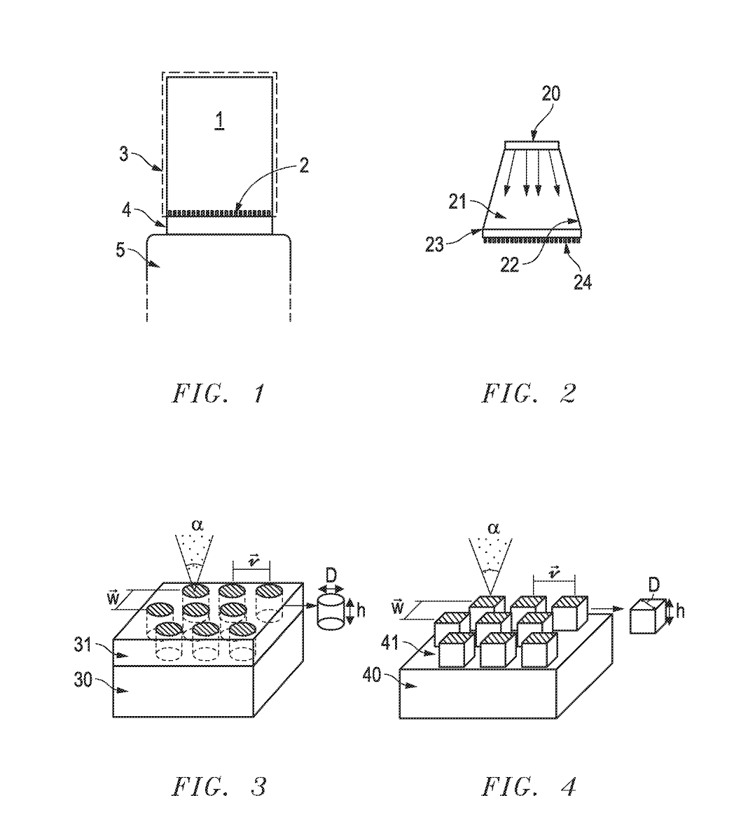

FIG. 3 shows one portion of the face of a scintillator 30 coated with a textured layer 31 of embodiments herein. The textured layer 31 includes a plurality of identical cylindrical holes juxtaposed regularly over the surface of the scintillator so that each cylindrical hole is surrounded by six identical holes at equal distance “a” therefrom, the distances being counted from axes of the pads (here, |\vec{v}|=|\vec{w}|=α). The angle alpha represents the angle inside of which the light originating from the scintillator is collimated.

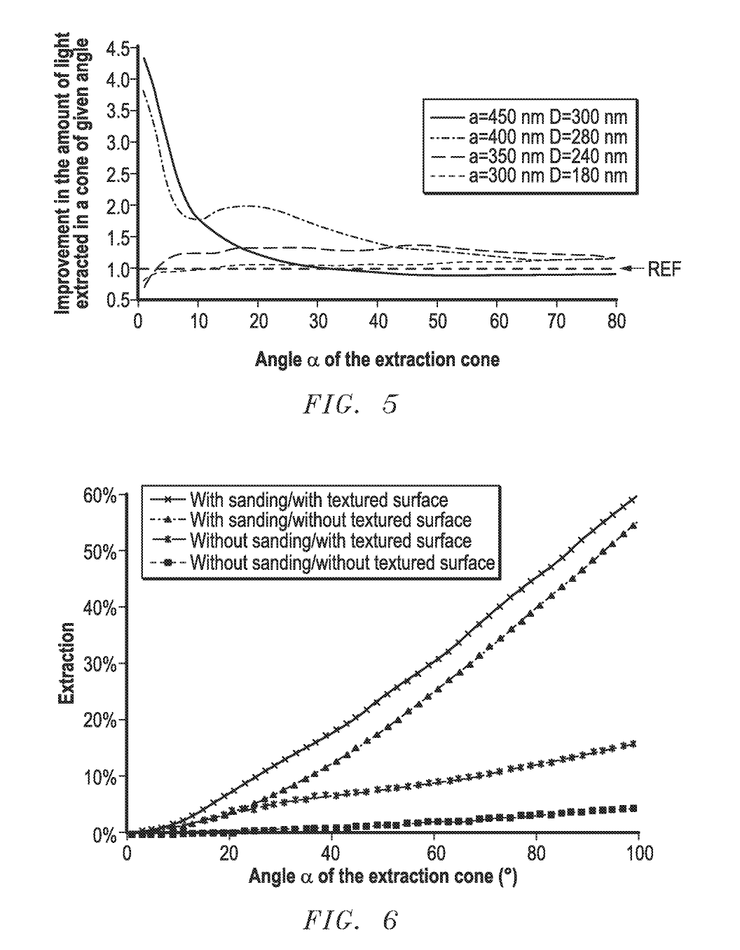

FIG. 4 shows one portion of the face of a scintillator 40 coated with a textured layer 41 of embodiments herein. The textured layer 41 includes a plurality of identical cylindrical pads juxtaposed regularly over the surface of the scintillator. Each cylindrical pad is surrounded by six identical pads at equal distance “a” therefrom, the distances being counted from axes of the pads (here, |\vec{v}|=|\vec{w}|=α). The angle alpha represents the angle inside of which the light originating from the scintillator is collimated.

FIG. 5 shows the influence of the parameters “a” and D on the increase in light extraction in the case of a single-crystal LYSO scintillator (emitting at λ_{SC}=420 nm) coated with an Si₃N₄ layer, applied and textured as in FIG. 3 by e-beam etching, the thickness of the layer, corresponding to the height of the cylindrical holes, being 450 nm.

The table below collates a few experimental values:

| a | D | λ_{SC}/a | D/a |
|---|---|---|---|
| 450 | 300 | 0.93 | 0.66 |
| 400 | 280 | 1.05 | 0.7 |
| 350 | 240 | 1.2 | 0.68 |
| 300 | 180 | 1.4 | 0.6 |

The results are expressed relative to the same crystal without a textured layer that gives a horizontal straight line passing through the value 1 on the y-axis. It may be seen that the best results are obtained for the values of “a” closest to 420 nm. The results are better when the angle (in degrees) of the extraction cone is smaller and are even exceptional below 20°.

FIG. 6 shows the percentage of light extracted via the exit surface of an LYSO scintillator emitting at λ_{SC}=420 nm as a function of extraction angle. The crystal was cylindrical and had a diameter of 63.2 mm and a height of 76.2 mm. Here 1 watt of light emitted in the middle of the crystal and in completely random directions is taken into account. All the possible configurations (with or without sanding of all the faces of the scintillator except the exit face, and with or without texture on the exit face) are compared. In the case of the presence of a textured layer on the exit face, the layer was made of Si₃N₄ textured with cylindrical holes of parameters a=|\vec{v}|=|\vec{w}|=400 nm, D=280 nm and H=450 nm. It may be seen that the combination of sanding and of a texture gives the best results. In particular, for an angle of extraction of 30°, the texturing increases by more than 50% the light extracted from a crystal with sanded surfaces.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.
Embodiment 1. A luminescent material comprising a face coated with a textured layer, the texture of said layer comprising identical features distributed uniformly over said face, said layer decreasing the angle of the extraction cone of light emitted by said luminescent material and passing through said face, the thickness of said layer being comprised in the range extending from 10 nm to 1000 nm.
Embodiment 2. The luminescent material as claimed in the preceding embodiment, characterized in that the features are pads or holes.
Embodiment 3. The luminescent material as embodied in one of the preceding embodiments, characterized in that the material of the textured layer has a refractive index comprised in the range extending from 0.8 to 1.2 times and preferably 0.9 to 1.1 times the refractive index of the luminescent material.
Embodiment 4. The luminescent material as embodied in one of the preceding embodiments, characterized in that λ_{SC}/a is comprised in the range extending from 0.5 to 1.5 and preferably from 0.8 to 1.3 and more preferably from 0.85 to 1.1, λ_{SC} representing the emission wavelength of the luminescent material and “a” representing the distance between the features.
Embodiment 5. The luminescent material as embodied in one of the preceding embodiments, characterized in that D/a is comprised in the range extending from 0.2 to 0.8, “D” representing the characteristic size of the features and “a” representing the distance between the features.
Embodiment 6. The luminescent material as embodied in one of the preceding embodiments, characterized in that the thickness of the layer is comprised in the range extending from 100 nm to 500 nm.
Embodiment 7. The luminescent material as embodied in one of the preceding embodiments, characterized in that the textured layer is made of silicon nitride or titanium oxide.
Embodiment 8. The luminescent material as embodied in one of the preceding embodiments, characterized in that the uncoated faces of the textured layer are rough and coated with a reflective material.
Embodiment 9. The luminescent material as claimed in one of the preceding embodiments, characterized in that it is a scintillator material.
Embodiment 10. The luminescent material as embodied in the preceding embodiments, characterized in that the uncoated faces of the textured layer are rough and coated with a reflective material made of PTFE leaving air between the scintillator material and itself.
Embodiment 11. A device comprising a material as embodied in either of embodiments 9 and 10, said material being coupled to at least one photodetector via the coated face of the textured layer by way of an optical coupling system with acceptance angles of less than 45°.
Embodiment 12. The device as claimed in the preceding embodiment, characterized in that the optical coupling system has an acceptance angle of less than 20° and even of less than 10°.
Embodiment 13. A device comprising a material as embodied in either of embodiments 9 and 10, said material being coupled to a photodetector via the face coated with the textured layer, said detector being separated from the material by a distance of at least 5 cm or even at least 1 m.
Embodiment 14. An imaging device comprising a material as embodied in either of embodiments 9 and 10, said material being coupled to a plurality of photodetectors via the face coated with the textured layer.
Embodiment 15. A device comprising a material as embodied in either of embodiments 9 and 10, said material being coupled to a photodetector via the face coated with the textured layer, the power response of the photodetector to an incident ray varying by more than 10% when the angle of incidence relative to the normal to the receiving surface of the photodetector is varied from 0 to 80°.
Embodiment 16. A projection lamp comprising a light source and a plate of the luminescent material as embodied in one of embodiments 1 to 7, the light source emitting light toward a first face of the plate, the second face of the plate being coated with the textured layer.
Embodiment 17. The lamp as embodied in the preceding embodiment, characterized in that the luminescent material converts the invisible incident light into visible emergent light.
Embodiment 18. The lamp as embodied in either of the two preceding embodiments, characterized in that the luminescent material is of the YAG or GAG or GYGAG type and especially of the YAG:Ce or GAG:Ce or GYGAG:Ce type.

What is claimed is:

1. A luminescent material, comprising a face coated with a textured layer, a texture of said textured layer comprising identical features distributed uniformly over said face, said textured layer configured to decrease an angle of an extraction cone of light emitted by said luminescent material and passing through said face, a thickness of said layer being in a range extending from 10 nm to 1000 nm.

2. The luminescent material as claimed in claim 1, wherein the features comprise pads or holes.

3. The luminescent material as claimed in claim 1, wherein the textured layer comprises a refractive index in a range extending from 0.8 to 1.2 times times an refractive index of the luminescent material.

4. The luminescent material as claimed in claim 3, wherein the textured layer comprises the refractive index in the range extending from 0.9 to 1.1 times the refractive index of the luminescent material.

5. The luminescent material as claimed in claim 1, wherein λ_{SC}/a is in a range extending from 0.5 to 1.5, λ^{SC} representing an emission wavelength of the luminescent material and “a” representing a distance between two neighboring features.

6. The luminescent material as claimed in claim 5, wherein λ_{SC}/a is in the range extending from 0.8 to 1.3

7. The luminescent material as claimed in claim 1, wherein D/a is in a range extending from 0.2 to 0.8, “D” representing a characteristic size of the features and “a” representing a distance between two neighboring features.

8. The luminescent material as claimed in claim 1, wherein the thickness of the textured layer is in the range extending from 100 nm to 500 nm.

9. The luminescent material as claimed in claim 1, wherein the textured layer comprises silicon nitride or titanium oxide.

10. The luminescent material as claimed in claim 1, wherein at least one of other faces of the luminescent layer is rough and coated with a reflective material.

11. The luminescent material as claimed in claim 10, wherein the luminescent material is a scintillator material.

12. The luminescent material as claimed in claim 11, wherein other faces of the luminescent material are rough and coated with a reflective material including PTFE, wherein air is kept between the reflective material and the luminescent material.

13. A device comprising a material as claimed in claim 11, said material being coupled to at least one photodetector via the face coated with the textured layer by an optical coupling system with an acceptance angle of less than 45°.

14. The device as claimed in claim 13, wherein the optical coupling system has the acceptance angle of less than 20°.

15. A device comprising a material as claimed in claim 11, said material being coupled to a photodetector via the face coated with the textured layer, said detector being separated from the material by a distance of at least 5 cm.

16. The device as claimed in claim 15, wherein said detector being separated from the material by the distance of at least 1 m.

17. An imaging device comprising a material as claimed in claim 11, said material being coupled to a plurality of photodetectors via the face coated with the textured layer.

18. A device comprising a material as claimed in claim 11, said material being coupled to a photodetector via the face coated with the textured layer, a power response of the photodetector to an incident ray varying by more than 10% when an angle of incidence relative to the normal to a light receiving surface of the photodetector is varied from 0 to 80°.

19. A projection lamp, comprising a light source and a plate of the luminescent material as claimed in claim 1, the light source configured to emmit light toward a first face of the plate, a second face of the plate being coated with the textured layer.

20. The projection lamp as claimed in claim 19, wherein the luminescent material is configured to convert invisible incident light into visible emergent light.

21. The projection lamp as claimed in claim 19, wherein the luminescent material is of a YAG or GAG or GYGAG type.

22. The projection lamp as claimed in claim 19, wherein the luminescent material is of a YAG:Ce or GAG:Ce or GYGAG:Ce type.
